(19) United States
(12) Patent Application Publication
(10) Pub. No.: US 2016/0339650 A1
(43) Pub. Date: Nov. 24, 2016

(54) MANUFACTURING METHOD OF TANK AND TANK MANUFACTURING APPARATUS

(71) Applicant: TOYOTA JIDOSHA KABUSHIKI KAISHA, Toyota-shi (JP)

(72) Inventors: Masato UEDA, Toyota-shi (JP); Tomoyoshi KOBAYASHI, Toyota-shi (JP); Kei KATO, Toyota-shi (JP)

(73) Assignee: TOYOTA JIDOSHA KABUSHIKI KAISHA, Toyota-shi (JP)

(21) Appl. No.: 15/151,652

(22) Filed: May 11, 2016

(30) Foreign Application Priority Data
May 18, 2015 (JP) 2015-100816

(51) Int. Cl. B29C 70/68; B29C 70/38

(52) U.S. Cl. CPC B29C 70/68; B29C 70/382; B29K 2063/00

(57) ABSTRACT

There is provided a manufacturing method of a tank. The manufacturing method comprises a preparation process of providing a fiber bundle in which a resin adheres to at least part of fibers when the fiber bundle is viewed in a section perpendicular to a longitudinal direction of fibers and in which an amount of the resin adhering to fibers on one side of the fiber bundle is smaller than an amount of the resin adhering to fibers On the other side of the fiber bundle in the section; and a winding process of winding the fiber bundle on a rolling body that includes a liner and a fiber bundle already wound on the liner, such that the fibers on the other side of the fiber bundle is located below the fibers on the one side in a stacking direction of the fiber bundle when the fiber bundle is stacked on the liner.

### CROSS-REFERENCE TO RELATED APPLICATIONS

The present application claims priority from Japanese patent application No. 2015-100816 filed on May 18, 2015, the content of which is hereby incorporated by reference into this application.

### BACKGROUND

1. Field

The present invention relates to a manufacturing method of a tank and a tank manufacturing apparatus.

2. Related Art

A known manufacturing method employs a filament winding method (hereinafter simply referred to as “FW method”) to manufacture a high-pressure tank for storing a fuel used for a natural gas vehicle or a fuel cell vehicle. The manufacturing method of the high-pressure tank by the FW method winds a reinforced fiber that is impregnated with a thermosetting resin such as an epoxy resin, on the outer circumference of a liner and heats and cures the thermosetting resin to form a fiber-reinforced resin layer.

In the process of winding the fiber impregnated with the resin on the outer circumference of the liner, winding the fiber during rotation of the liner causes a problem that the resin adhering to the wound fiber is splashed by the centrifugal force.

### SUMMARY

In order to solve at least part of the above problems, the invention may be implemented by any of the following aspects.

(1) According to one aspect of the invention, there is provided a manufacturing method of a tank. The manufacturing method comprises a preparation process of providing a fiber bundle in which a resin adheres to at least part of fibers when the fiber bundle is viewed. in a section perpendicular to a longitudinal direction of fibers and in which an amount of the resin adhering to fibers on one side of the fiber bundle is smaller than an amount of the resin adhering to fibers on the other side of the fiber bundle in the section; and a winding process of winding the fiber bundle on a rolling body that includes a liner and a fiber bundle already wound on the liner, such that the fibers on the other side of the fiber bundle is located below the fibers on the one side in a stacking direction of the fiber bundle when the fiber bundle is stacked on the liner.

According to this aspect, in the fiber bundle placed on the surface of the rolling body by the winding process, the amount of the resin adhering to the fibers on the upper side in the stacking direction is smaller than the amount of the resin adhering to the fibers on the lower side in the stacking direction. This reduces the amount of splashed resin. The relatively large amount of the resin included in the fibers on the lower side in the stacking direction is blocked by the fibers on the upper side in the stacking direction and is thus unlikely to be splashed. This configuration reduces the total amount of the resin splashed by the centrifugal force from the resin adhering to the wound fiber bundle in the process of rotating the rolling body, compared with the amount of splashed resin in the configuration that the amount of the resin adhering to the fibers on the upper side in the stacking direction is equal to the amount of the resin adhering to the fibers on the lower side in the stacking direction.

(2) In the manufacturing method of the above aspect, the preparation process may comprise a process of providing the fiber bundle in which no resin adheres to the fibers on the one side of the fiber bundle.

According to this aspect, in the fiber bundle wound on the rolling body, no resin adheres to the fibers on the upper side in the stacking direction. This further suppresses splash of the resin adhering to the wound fiber bundle in the process of rotating the rolling body.

(3) In the manufacturing method of the above aspect, the preparation process may comprise a process of providing the fiber bundle by bundling resin-impregnated fibers and non-resin-impregnated fibers.

This configuration can readily provide the fiber bundle in which the amount of the resin adhering to the fibers on one side of the fiber bundle is smaller than the amount of the resin adhering to the fibers on the other side.

(4) In the manufacturing method of the above aspect, the preparation process may comprise a process of providing the fiber bundle by bringing a resin sheet into contact with the fibers on the other side of the fiber bundle.

This configuration can also readily provide the fiber bundle in which the amount of the resin adhering to the fibers on one side of the fiber bundle is smaller than the amount of the resin adhering to the fibers on the other side.

(5) According to another aspect of the invention, there is provided a tank manufacturing apparatus. The tank manufacturing apparatus comprises a fiber bundle supplier that is configured to supply a fiber bundle in which a resin adheres to at least part of fibers when the fiber bundle is viewed in a section perpendicular to a longitudinal direction of fibers and in which an amount of the resin adhering to fibers on one side of the fiber bundle is smaller than an amount of the resin adhering to fibers on the other side of the fiber bundle in the section; and a fiber feeder configured to wind the fiber bundle on a rolling body that includes a liner and a fiber bundle already wound on the liner, such that the fibers on the other side of the fiber bundle is located below the fibers on the one side in a stacking direction of the fiber bundle when the fiber bundle is stacked on the liner.

According to this aspect, in the fiber bundle placed on the surface of the rolling body by the fiber feeder, the amount of the resin adhering to the fibers on the upper side in the stacking direction is smaller than the amount of the resin adhering to the fibers on the lower side in the stacking direction. This reduces the amount of splashed resin. The relatively large amount of the resin included in the fibers on the lower side in the stacking direction is blocked by the fibers on the upper side in the stacking direction and is thus unlikely to be splashed. This configuration reduces the total amount of the resin splashed by the centrifugal force from the resin adhering to the wound fiber bundle in the process of rotating the rolling body, compared with the amount of splashed resin in the configuration that the amount of the resin adhering to the fibers on the upper side in the stacking direction is equal to the amount of the resin adhering to the fibers on the lower side in the stacking direction.

(6) In the manufacturing apparatus of the above aspect, the fiber bundle supplier may comprise a first fiber wind-off assembly and a second fiber wind-off assembly that are respectively configured to wind off fibers; and a resin impregnation assembly configured to impregnate the fibers wound off from the second fiber wind-off assembly with the resin. The fiber bundle supplier may supply the fiber bundle by bundling the fibers impregnated with the resin by the resin impregnation assembly and the fibers wound off from the first fiber wind-off assembly.

This configuration can readily provide the fiber bundle in which the amount of the resin adhering to the fibers on one side of the fiber bundle is smaller than the amount of the resin adhering to the fibers on the other side.

(7) in the manufacturing apparatus of the above aspect, the fiber bundle supplier may comprise a fiber wind-off assembly that is configured to wind off fibers; and a resin supplier that is configured to cause the resin to adhere to the fibers wound off from the fiber wind-off assembly.

This configuration can also readily provide the fiber bundle in which the amount of the resin adhering to the fibers on one side of the fiber bundle is smaller than the amount of the resin adhering to the fibers on the other side.

(8) In the manufacturing apparatus of the above aspect, the fiber bundle supplier may comprise a fiber wind-off assembly that is configured to wind off fibers; and a resin sheet supplier that is configured to supply a resin sheet. The fiber bundle supplier may supply the fiber bundle by causing the resin sheet supplied from the resin sheet supplier to come in contact with the fibers wound off from the fiber wind-off assembly.

This configuration can also readily provide the fiber bundle in which the amount of the resin adhering to the fibers on one side of the fiber bundle is smaller than the amount of the resin adhering to the fibers on the other side.

The invention may be implemented by any of various aspects other than those described above, for example, a method of winding a fiber bundle on a rolling body, a filament winding apparatus, a control method of any of the apparatuses, a computer program for implementing the control method, and a non-transitory storage medium in which the computer program is stored.

### BRIEF DESCRIPTION OF DRAWINGS

FIG. 1 is a flowchart showing a procedure of tank manufacturing process according to a first embodiment;

FIG. 2 is a diagram illustrating a filament winding apparatus according to the first embodiment;

FIG. 3 is a diagram illustrating the state of a rolling body and a resin-localized carbon fiber bundle;

FIG. 4 is a diagram illustrating the state of a rolling body and a resin-localized carbon fiber bundle according to a comparative example;

FIG. 5 is a diagram illustrating a filament winding apparatus according to a second embodiment;

FIG. 6 is a diagram illustrating a filament winding apparatus according to a third embodiment;

FIG. 7 is a diagram illustrating a filament winding apparatus according to a fourth embodiment;

FIG. 8 is a diagram illustrating a filament winding apparatus according to a fifth embodiment;

FIG. 9 is a diagram illustrating a filament winding apparatus according to a sixth embodiment;

FIG. 10 is a diagram illustrating a section of a resin-localized carbon fiber bundle; and

FIG. 11 is a diagram illustrating a filament winding apparatus according to a seventh embodiment.

### DETAILED DESCRIPTION

### A. First Embodiment

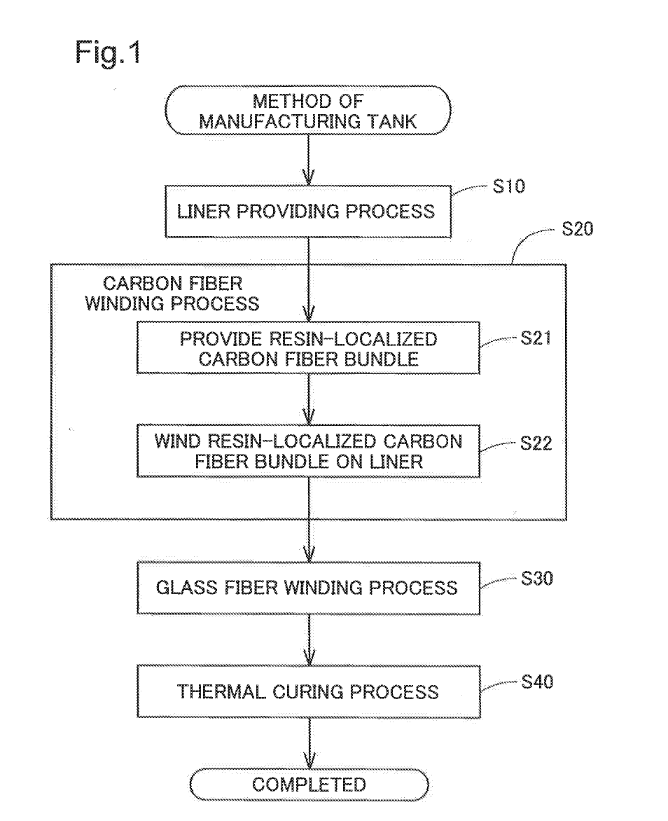

FIG. 1 is a flowchart showing a procedure of tank manufacturing process according to a first embodiment. This manufacturing process employs the filament winding method (FW method) to manufacture a high-pressure tank configured to store a high-pressure fluid such as high-pressure hydrogen or high-pressure natural gas. A liner providing process at step S10 provides a liner as the core material of forming the shape of a formed product. The liner is a hollow vessel that constitutes a main body of the high-pressure tank, and includes a cylinder portion in an approximately cylindrical shape and dome portions in an approximately hemispherical shape provided on both ends of the cylinder portion although not being specifically illustrated. The liner is made of, for example, hard plastic. The liner may be a tube corresponding to the inner diameter of the tank.

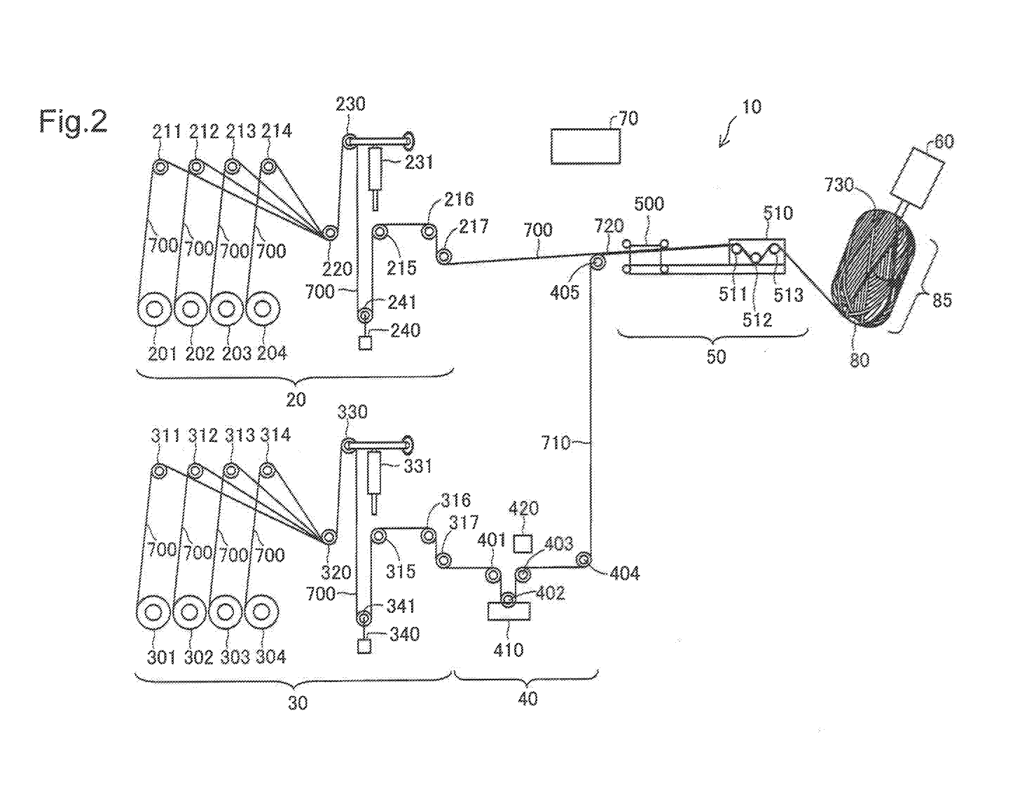

A carbon fiber winding process at subsequent step S20 winds a carbon fiber bundle consisting of a plurality of carbon fibers on the provided liner. A filament winding apparatus (shown in FIG. 2) is used to wind the carbon fiber bundle on the liner. The carbon fiber winding process of this embodiment includes a preparation process of providing a resin-localized carbon fiber bundle 720 described later (step S21) and a winding process of winding this resin-localized carbon fiber bundle 720 on the liner (step S22). The resin-localized carbon fiber bundle 720 is a fiber bundle in which a resin adheres to at least part of the fibers when being viewed in a section perpendicular to the longitudinal direction of the fibers. More specifically, when being viewed in the above section, the resin-localized carbon fiber bundle 720 is a carbon fiber bundle in which the amount of the resin adhering to the fibers on one side of the carbon fiber bundle is smaller than the amount of the resin adhering to the fibers on the other side of the carbon fiber bundle. A method of producing the resin-localized carbon fiber bundle 720 will be described later. The resin-localized carbon fiber bundle 720 is impregnated with a required amount of the resin to form a fiber-reinforced resin layer on the outer surface of the liner.

After the carbon fibers are wound on the liner, glass fibers impregnated with a resin are further wound on the liner with the carbon fibers wound on the outer surface thereof (step S30). It is preferable to repeat winding of the carbon fibers ten to forty times and winding of the glass fibers one to four times. This embodiment uses the resin-localized carbon fiber bundle 720, since the resin-localized carbon fiber bundle 720 more effectively suppresses splash of the resin in the process of winding the carbon fibers by rotating the liner at a relatively high speed due to the large number of times of winding. After winding the glass fibers, a thermal curing process is performed for the liner having the glass fibers wound outside of the carbon fibers (step S40). The thermal curing process heats the liner, for example, in a heating furnace. The thermal curing process cures the carbon fibers wound on the outer circumference of the liner and the resin which the glass fibers are impregnated with, so as to produce a fiber-reinforced resin composite product. Components such as mouthpieces may be attached prior to winding the carbon fiber bundle at step S20 or may be attached to the fiber-reinforced resin composite product after the thermal curing process. The high-pressure tank is completed by this series of processes.

FIG. 2 is a diagram illustrating a filament winding apparatus 10 according to the first embodiment. The filament winding apparatus 10 performs the preparation process (step S21) and the winding process (step S22) described above. The filament winding apparatus 10 includes a first fiber wind-off assembly 20 a second fiber wind-off assembly 30, a resin impregnation assembly 40, a joint guide assembly 50, a liner rotating device 60 and a controller 70. The fiber wind-off assemblies 20 and 30 and the resin impregnation assembly 40 correspond to the “fiber bundle supplier”.

The first fiber wind-off assembly 20 is a mechanical unit configured to wind off the carbon fibers and includes a plurality of bobbins 201 to 204, a plurality of feed rollers 211 to 217, a bundle roller 220, a tension roller 230 and an active dancer 240. The bobbins 201 to 204 are tubular members for winding yarns, and carbon fiber bundles 700 are wound on the respective bobbins 201 to 204. The carbon fiber bundle 700 is, for example, a fiat sheet of about 200 μm in thickness and about 4 mm to 5 mm in width produced by firing polyacrylonitrile raw yarns at about 3000° C., collectively twisting about 24,000 fired yarns and making the twisted yarns lightly adhere to one another with a binder resin. The feed rollers 211 to 214 are provided corresponding to the respective bobbins 201 to 204 to feed the carbon fiber bundles 700 wound off from the bobbins 201 to 204 to the bundle roller 220. The bundle roller 220 aligns the carbon fiber bundles 700 wound off from the bobbins 201 to 204 and winds off the aligned carbon fiber bundles 700 to the tension roller 230. The tension roller 230 includes a cylinder 231 that is set to have a predetermined pressure, and applies a predetermined tensile force to the carbon fiber bundle 700. The active dancer 240 moves a roller 241 to adjust the tensile force of the carbon fiber bundle 700. The carbon fiber bundle 700 of the adjusted tensile force is conveyed through the feed rollers 215 to 217 to the joint guide assembly 50.

The second fiber wind-off assembly 30 is a mechanical unit similar to the first fiber wind-off assembly 20 and includes a plurality of bobbins 301 to 304, a plurality of feed rollers 311 to 317, a bundle roller 320, a tension roller 330 and an active dancer 340. The functions and the configuration of the bobbins 301 to 304, the feed rollers 311 to 317, the bundle roller 320, the tension roller 330 and the active dancer 340 are similar to those of the bobbins 201 to 204, the feed rollers 211 to 217, the bundle roller 220, the tension roller 230 and the active dancer 240 of the first fiber wind-off assembly 20. The feed rollers 315 to 317, however, wind off the carbon fiber bundle 700 to the resin impregnation assembly 40.

The resin impregnation assembly 40 is a mechanical unit configured to impregnate the carbon fiber bundle 700 with an epoxy resin and includes a plurality of feed rollers 401 to 405, a resin impregnation tank 410 and a film thickness measurement device 420. The feed rollers 401 to 405 feed the carbon fiber bundle 700 inside of the resin impregnation assembly 40. The resin impregnation tank 410 stores a thermosetting epoxy resin in the liquid state that is heated in a range of 40° C. to 50° C. and is under viscosity control. The carbon fiber bundle 700 is fed below the feed roller 402 to be soaked in the thermosetting epoxy resin in the resin impregnation tank 410. Hereinafter the carbon fiber bundle 700 soaked in the thermosetting epoxy resin is called “resin-impregnated. carbon fiber bundle 710”. The film thickness measurement device 420 measures the thickness of the thermosetting epoxy resin of the resin-impregnated carbon fiber bundle 710. The resin-impregnated carbon fiber bundle 710 wound off from the feed roller 405 and the carbon fiber bundle 700 conveyed from the first fiber wind-off assembly 20 are stacked. and. are conveyed to the joint guide assembly 50. In the resulting carbon fiber bundle obtained by stacking and bundling the resin-impregnated carbon fiber bundle 710 wound off from the feed roller 405 and the carbon fiber bundle 700 conveyed from the first fiber wind-off assembly 20, the resin does not adhere to the fibers on one side (carbon fiber bundle 700-side), while the resin adheres to the fibers on the other side (resin-impregnated carbon fiber bundle 710-side). In other words, the resulting carbon fiber bundle has the resin locally adhering to part of the fibers, such that the amount of the resin adhering to the fibers on one side of the carbon fiber bundle is smaller than the amount of the resin adhering to the fibers on the other side of the carbon fiber bundle. Hereinafter this resulting carbon fiber bundle is called “resin-localized carbon fiber bundle 720”.

The joint guide assembly 50 is a mechanism configured to align the resin-localized carbon fiber bundles 720 and guide the aligned resin-localized carbon fiber bundles 720 to the outer surface of the liner 80 and includes an alignment port 500 and a fiber feeder 510. The alignment port 500 collects, arrays and aligns the resin-localized carbon fiber bundles 720 in the width direction. The fiber feeder 510 includes a first joint roller 511, a second joint roller 512 and a third joint roller 513 and uses these three joint rollers 511 to 513 to convey the resin-localized carbon fiber bundle 720 to the liner 80.

The liner rotating device 60 supports the liner 80 in a rotatable manner and rotates the liner 80 around a longitudinal axis of the liner 80. The liner rotating device 60 rotates the liner 80 to wind the resin-localized carbon fiber bundle 720 on the liner 80 with applying a tensile force to the resin-localized carbon fiber bundle 720. The resin-localized carbon fiber bundle 720 is accordingly wound on the surface of the liner 80 as combination of hoop winding and helical winding. Hereinafter the liner 80 and a carbon fiber bundle 730 already wound on the liner 80 are collectively called “rolling body 85”. The resin-localized carbon fiber bundle 720 is wound to be in contact with the surface of the rolling body 85. The speed of rotation of the liner 80 is about 100 to 300 rpm at most

The controller 70 controls the temperature of the resin impregnation tank 410 such as to provide a uniform thickness of the thermosetting epoxy resin of the resin-impregnated carbon fiber bundle 710 measured by the film thickness measurement device 420. The thickness of the thermosetting epoxy resin of the resin-impregnated carbon fiber bundle 710 is determined to provide a required amount, of the resin in the resin-localized carbon fiber bundle 720 after being bundled with the carbon fiber bundle 700. The controller 70 controls the operation of the active dancer 340, the move of the fiber feeder 510, and the move and rotation of the liner 80. The controller 70 may be configured to control the rotation speed of the liner rotating device 60 according to the tensile force of the resin-impregnated carbon fiber bundle 710.

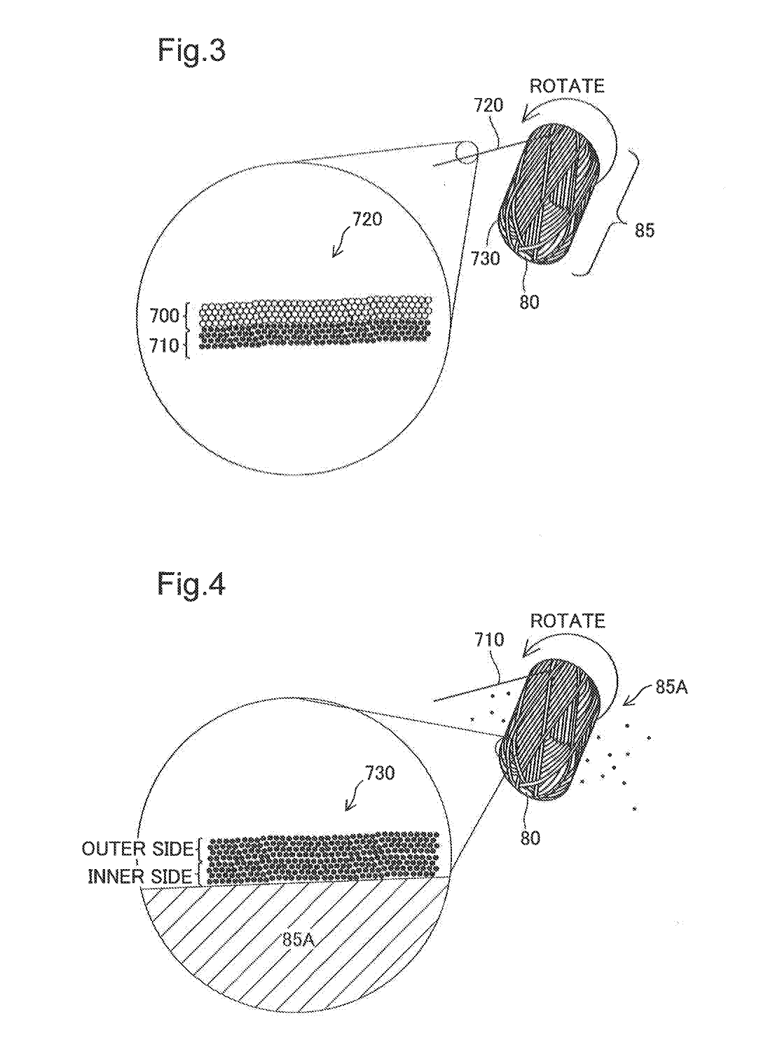

FIG. 3 is a diagram illustrating the state that the resin-localized carbon fiber bundle 720 is wound on the outer circumference of the rolling body 85. FIG. 3 schematically illustrates a section of the resin-localized carbon fiber bundle 720. The resin-localized carbon fiber bundle 720 fed out of the fiber feeder 510 (shown in FIG. 2) has an end fixed to a winding start region (not shown) of the liner 80 and is wound and stacked on the outer circumference of the liner 80 by rotation of the liner 80. The resin-localized carbon fiber bundle 720 is wound to be in contact with the surface of the rolling body 85 such that the resin-impregnated carbon fibers 710-side of the resin-localized carbon fiber bundle 720 (lower side in the circle of FIG. 3) is located on the lower side in the stacking direction of the resin-localized carbon fiber bundle 720. More specifically, the resin-localized carbon fiber bundle 720 is wound on the roiling body 85 such that the resin-impregnated carbon fibers 710-side is in contact with the surface of the liner 80 or in contact with the surface of the carbon fiber bundle 730 already wound on the liner 80, and the non-resin-impregnated, dry carbon fibers 700-side (upper side in the circle of FIG. 3) is located on the upper side in the stacking direction of the resin-localized carbon fiber bundle 720. In the carbon fiber bundle 730 placed on the surface of the rolling body 85, the fiber bundle that is impregnated with the resin is located on the inner side of the fiber bundle that is not impregnated with the resin. This configuration suppresses splash of the resin from the outer surface of the rolling body 85 in the process of rotating the rolling body 85.

As long as the amount of the resin adhering to the fibers on one side is larger than the amount of the resin adhering to the fibers on the other side, the resin may adhere to the fibers on both sides of the resin-localized carbon fiber bundle 720. The resin-localized carbon fiber bundle 720 of this modified configuration is to be wound such that the fibers on the side having the relatively large amount of the resin are in contact with the surface of the rolling body 85. The amount of the resin adhering to the fibers on the upper side in the stacking direction of the carbon fiber bundle 730 wound on the rolling body 85 is accordingly made smaller than the amount of the resin adhering to the fibers on the lower side in the stacking direction. This reduces the amount of splash of the resin adhering to the carbon fiber bundle 730 from the outer surface of the rolling body 85 in the process of rotating the rolling body 85. It is preferable that the amount of the resin adhering to the fibers on the upper side in the stacking direction causes only an allowable level of splash even when the centrifugal force is generated in the process of winding. It is, however, more preferable that no resin adheres to the fibers on the upper side in the stacking direction of the carbon fiber bundle 730 wound on the rolling body 85. This configuration causes substantially no deterioration of the performance of a final product since the resin adhering to the fibers on the lower side in the stacking direction of the carbon fiber bundle 730 partly adheres to the fibers on the upper side in the stacking direction.

FIG. 4 is a diagram illustrating the state that the resin-impregnated carbon fiber bundle 710 is wound on the outer circumference of a rolling body 85A according to a comparative example. The resin-impregnated carbon fiber bundle 710 is wound on the rolling body 85A of the comparative example. In this comparative example, the amount of the resin adhering to the fibers on the upper side in the stacking direction (“outer side” in FIG. 4) of the carbon fiber bundle 730 wound on the rolling body 85A is substantially equivalent to the amount of the resin adhering to the fibers on the lower side in the stacking direction (“inner side” in FIG. 4). The resin adhering to the carbon fiber bundle 730 is thus likely to be splashed in the process of rotating the rolling body 85A.

As described above, in the method of manufacturing the tank according to the embodiment, at the winding process (step S22) of FIG. 1, the resin-localized carbon fiber bundle 720 is wound on the rolling body 85 such that the carbon fibers 700-side of the resin-localized carbon fiber bundle 720 (upper side in the circle of FIG. 3) is located on the upper side in the stacking direction on the rolling body 85. This suppresses the resin adhering to the carbon fiber bundle 730 wound on the rolling body 85 from being splashed in the process of rotating the rolling body 85. The relatively large amount of the resin included in the fibers on the lower side in the stacking direction is blocked by the fibers on the upper side in the stacking direction and is thus unlikely to be splashed. This reduces the total amount of the resin splashed by the centrifugal force from the resin adhering to the wound carbon fiber bundle 730 in the process of rotating the rolling body 85, compared with the comparative example shown in FIG. 4. Recently there has been a need to increase the rotation speed of the rolling body 85 with a view to improving the efficiency of manufacturing the tank. Increasing the rotation speed of the rolling body 85 results in increasing the amount of the resin splashed from the rolling body 85. The splashed resin is likely to enter the various mechanical units of the filament winding apparatus and is also likely to adversely affect the human body. The configuration of this embodiment suppresses splash of the resin and accordingly suppresses the occurrence of these problems. This configuration also enables the rotation speed of the rolling body 85 to be increased and thereby improves the manufacturing efficiency. Additionally, the configuration of this embodiment enables the two layers of the carbon fiber bundle 700 and the resin-impregnated carbon fiber bundle 710 to be simultaneously wound on the liner 80 and thereby further improves the manufacturing efficiency.

### B. Second Embodiment

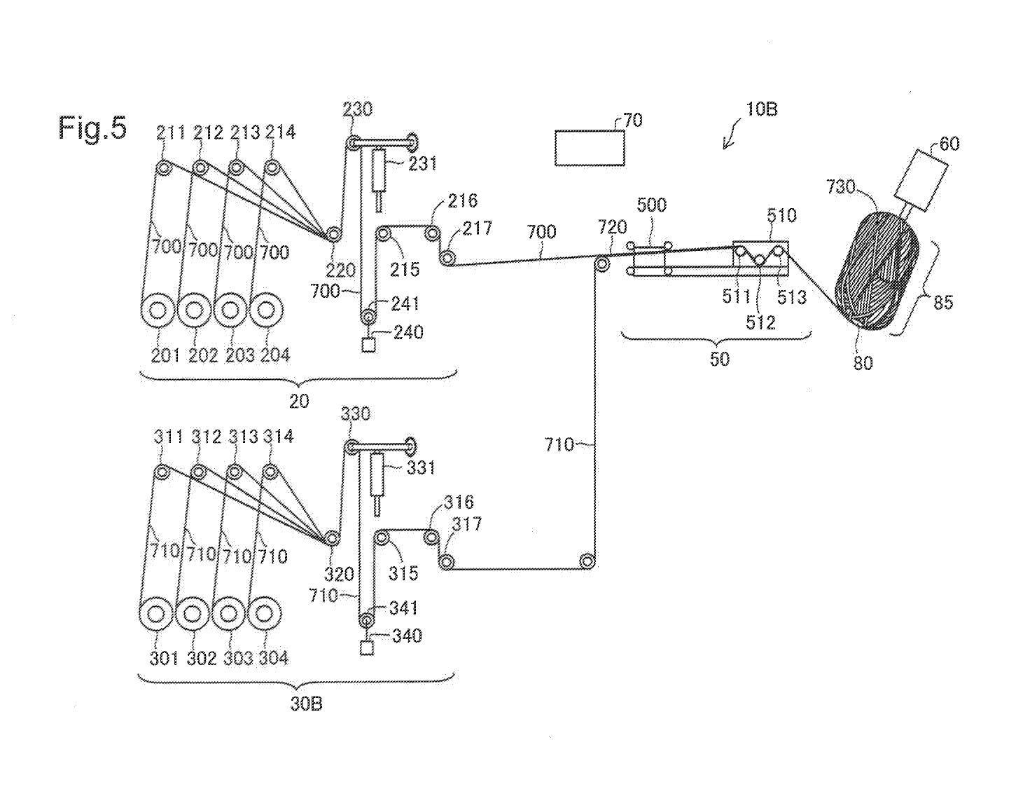

FIG. 5 is a diagram illustrating a filament winding apparatus 10B according to a second embodiment. The filament winding apparatus 10B of the second embodiment differs from the filament winding apparatus 10 of the first embodiment (shown in FIG. 2) by omission of the resin impregnation assembly 40. In a second fiber wind-off assembly 30B, a resin-impregnated carbon fiber bundle 710 after impregnation of a resin is wound on the respective bobbins 301 to 304. This configuration also enables the resin-localized carbon fiber bundle 720 (shown in FIG. 3) to be readily produced by simply stacking the non-resin-impregnated carbon fiber bundle 700 conveyed from the first fiber wind-off assembly 20 and the resin-impregnated carbon fiber bundle 710 conveyed from the second fiber wind-off assembly 30B.

### C. Third Embodiment

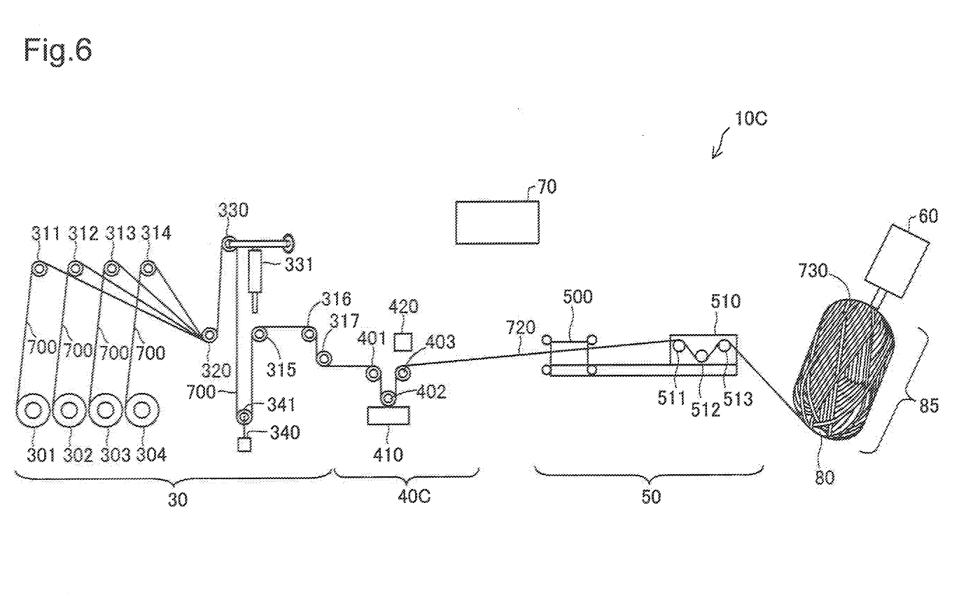

FIG. 6 is a diagram illustrating a filament winding apparatus 10C according to a third embodiment. The filament winding apparatus 10C of the third embodiment differs from the filament winding apparatus 10 of the first embodiment (shown in FIG. 2) by omission of the first fiber wind-off assembly 20. A resin impregnation assembly 40C of the third embodiment impregnates only part of the fibers of the carbon fiber bundle 700 wound off from the second fiber wind-off assembly 30 with a resin. More specifically the resin impregnation assembly 40C impregnates the fibers on one side of the carbon fiber bundle 700 with the resin, while not impregnating the fibers on the other side of the carbon fiber bundle 700 with the resin. This configuration also enables the resin-localized carbon fiber bundle 720 (shown in FIG. 3) to be readily produced.

### D. Fourth Embodiment

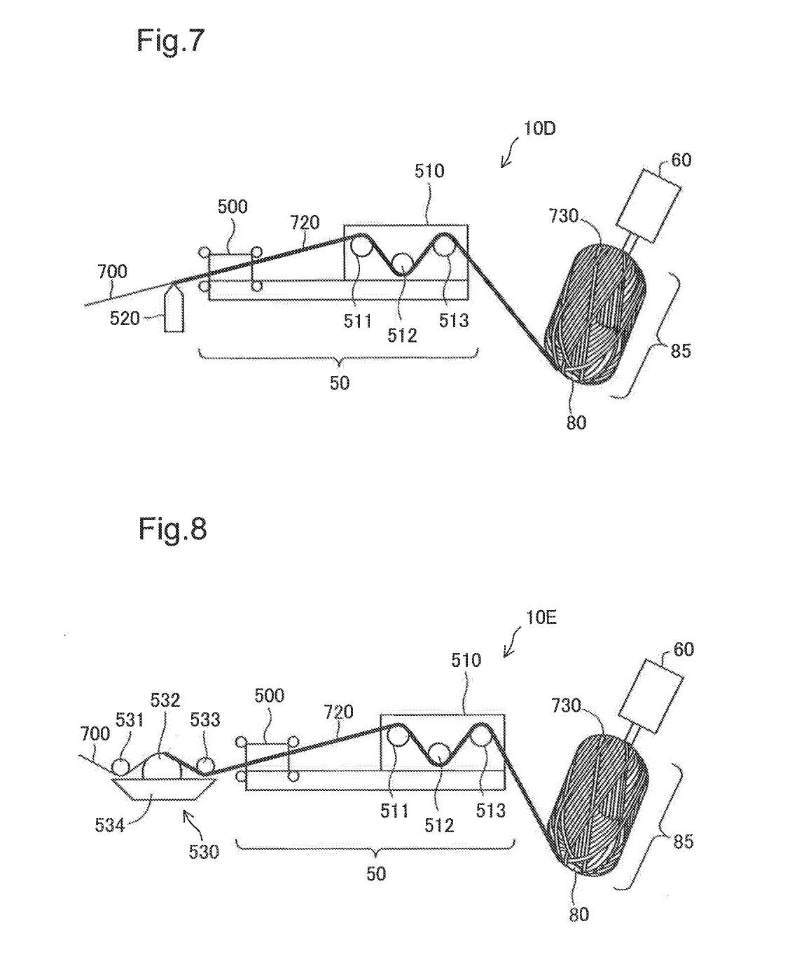

FIG. 7 is a diagram illustrating part of a filament winding apparatus 10D according to a fourth embodiment. FIG. 7 illustrates the periphery of a joint guide assembly 50 of the filament winding apparatus 10D. The filament winding apparatus 10D of the fourth embodiment differs from the filament winding apparatus 10 of the first embodiment (shown in FIG. 2) by omission of the second fiber wind-off assembly 30 and the resin impregnation assembly 40 and addition of a resin ejection assembly 520 placed upstream of the joint guide assembly 50. The resin ejection assembly 520 ejects a resin onto the fibers on one side (lower side in FIG. 7) of the carbon fiber bundle 700 conveyed from the first fiber wind-off assembly 20 (shown in FIG. 2). This provides a carbon fiber bundle in which the resin adheres to the fibers on one side and substantially no resin adheres to the fibers on the other side. This configuration also enables the resin-localized carbon fiber bundle 720 (shown in FIG. 3) to be readily produced. This embodiment does not require the resin impregnation tank 40 and thereby simplifies the configuration of the filament winding apparatus. The resin ejection assembly 520 corresponds to the “resin supplier”.

### E. Fifth Embodiment

FIG. 6 is a diagram illustrating part of a filament winding apparatus 10E according to a fifth embodiment. FIG. 8 illustrates the periphery of a joint guide assembly 50 of the filament winding apparatus 10E. The filament winding apparatus 10E of the fifth embodiment differs from the filament winding apparatus 10 of the first embodiment (shown in FIG. 2) by omission of the second fiber wind-off assembly 30 and the resin impregnation assembly 40 and addition of a resin application assembly 530 placed upstream of the joint guide assembly 50. The resin application assembly 530 includes a plurality of &ell. rollers 531 to 533 and a resin tank 534. The resin tank 534 stores a resin in the liquid state. Part of the feed roller 532 is exposed to the resin stored in the resin tank 534. The carbon fiber bundle 700 conveyed from the first fiber wind-off assembly 20 (shown in FIG. 2) to the resin application assembly 530 comes into contact with an upper portion of the feed roller 532, so that the resin on the surface of the feed roller 532 adheres to part of the carbon fiber bundle 700. This provides a carbon fiber bundle in which the resin adheres to the fibers on one side that comes into contact with the feed roller 532 and substantially no resin adheres to the fibers on the other side. This configuration also enables the resin-localized carbon fiber bundle 720 (shown in FIG. 3) to be readily produced. The resin application assembly 530 corresponds to the “resin supplier”.

### F. Sixth Embodiment

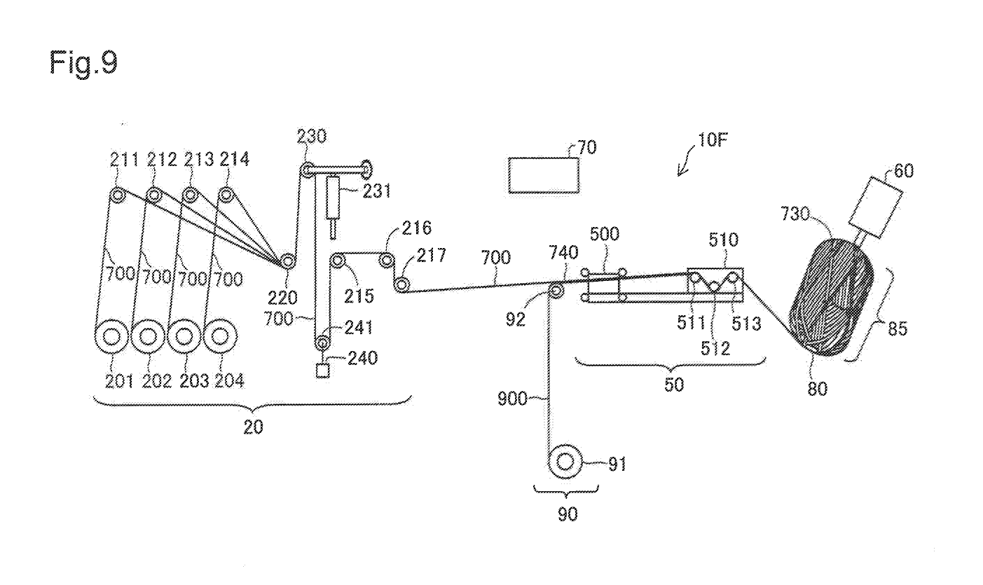

FIG. 9 is a diagram illustrating a filament winding apparatus 10F according to a sixth embodiment. The filament winding apparatus 10F of the sixth embodiment differs from the filament winding apparatus 10 of the first embodiment (shown in FIG. 2) by omission of the second fiber wind-off assembly 30 and the resin impregnation assembly 40 and addition of a resin sheet supplier 90. The resin sheet supplier 90 includes a bobbin 91 which a resin sheet 900 is wounded on and a feed roller 92. The resin sheet 900 wound off from the bobbin 91 and conveyed via the feed roller 92 and the carbon fiber bundle 700 conveyed from the first fiber wind-off assembly 20 are stacked and are conveyed to a joint guide assembly 50. Hereinafter a resulting carbon fiber bundle by stacking the carbon fiber bundle 70 conveyed from the first fiber wind-off assembly 20 and the resin sheet 900 conveyed from the resin sheet supplier 90 is called “resin-localized carbon fiber bundle 740”.

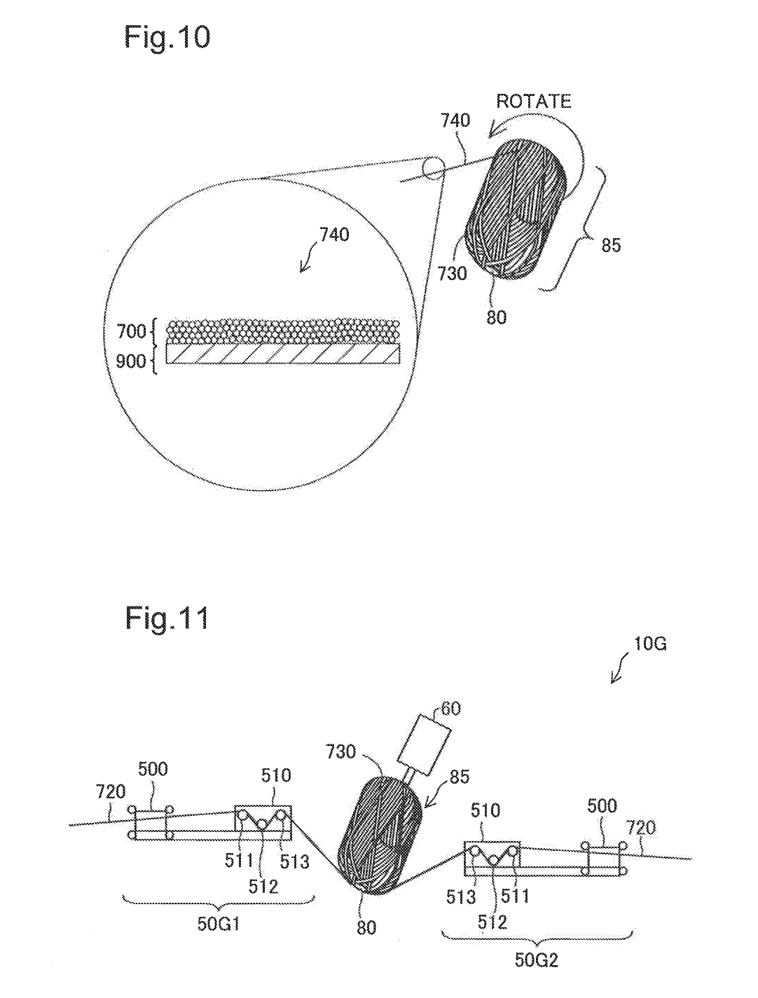

FIG. 10 is a diagram illustrating a section of the resin-localized carbon fiber bundle 740. When the carbon fiber bundle 700 conveyed from the first fiber wind-off assembly 20 and the resin sheet 900 conveyed from the resin sheet supplier 90 are stacked, the resin (resin sheet 900) adheres to the fibers on one side of the carbon fiber bundle 700, while substantially no resin adheres to the fibers on the other side of the carbon fiber bundle 700. This carbon fiber bundle also has the resin locally adhering to the fibers and is also called resin-localized carbon fiber bundle. This configuration also enables the resin-localized carbon fiber bundle to be readily produced.

### G. Seventh Embodiment

FIG. 11 is a diagram illustrating part of a filament winding apparatus 10G according to a seventh embodiment. FIG. 11 illustrates a first joint guide assembly 50G1 and a second joint guide assembly 50G2 of the filament winding apparatus 10G. The filament winding apparatus 10G of the seventh embodiment differs from the filament winding apparatus 10 of the first embodiment (shown in FIG. 2) by providing a plurality of joint guide assemblies. Both the first joint guide assembly 50G1 and the second joint guide assembly 50G2 are configured to convey the resin-localized carbon fiber bundles 720 to the liner 80. According to a modification, one of the first joint guide assembly 50G1 and the second joint guide assembly 50G2 may be configured to convey non-resin-impregnated carbon fiber bundle 700 and the other may be configured to convey the resin sheet or the resin-impregnated carbon fiber bundle 710. In this modification, the non-resin-impregnated carbon fiber bundle 700 is wound on the surface of the resin sheet or the resin-impregnated carbon fiber bundle 710 wound on the rolling body 85 by one of the joint guide assemblies. This also suppresses splash of the resin in the process of rotating the rolling body 85.

### H. Modifications

The invention is not limited to the embodiments described above but may be implemented by a diversity of other configurations without departing from the scope of the invention, Some examples of possible modification are given below.

### H-1. Modification 1

According to the embodiment (shown in FIG. 1), the preparation process (step S212) and the winding process (step S22) are performed in the carbon fiber winding process (step S20). According to a modification, these processes (steps S21 and S22) may be applied to the glass fiber winding process (step S30). More specifically, this modification may provide a resin-localized glass fiber bundle in which the amount of the resin adhering to the fibers on one side of the glass fiber bundle is smaller than the amount of the resin adhering to the fibers on the other side and wind this resin-localized glass fiber bundle such that the fibers on the side having the relatively large amount of the resin are in contact with the surface of the rolling body 85. This modified configuration suppresses splash of the resin in the glass fiber winding process.

### H-2. Modification 2

As long as the amount of the resin adhering to the fibers on one side is larger than the amount of the resin adhering to the fibers on the other side, the resin may adhere to the fibers on both sides of the resin-localized carbon fiber bundle 720. For example, a resin-localized carbon fiber bundle 720 may be produced by stacking two different resin-impregnated carbon fiber bundles 710 that are impregnated with different amounts of the resin. In this modification, the resin-localized carbon fiber bundle 720 is wound such that the resin-impregnated carbon fiber bundle 710 on the side having the relatively small amount of the resin is not in contact with the surface of the rolling body 85. This modified configuration reduces the amount of the splashed resin relative to the impregnation amount of the resin included in the carbon fiber bundle.

What is claimed is:

1. A manufacturing method of a tank, comprising:
a preparation process of providing a fiber bundle in which a resin adheres to at least part of fibers when the fiber bundle is viewed in a section perpendicular to a longitudinal direction of fibers and in which an amount of the resin adhering to fibers on one side of the fiber bundle is smaller than an amount of the resin adhering to fibers on the other side of the fiber bundle in the section; and
a winding process of winding the fiber bundle on a rolling body that includes a liner and a fiber bundle already wound on the liner, such that the fibers on the other side of the fiber bundle is located below the fibers on the one side in a stacking direction of the fiber bundle when the fiber bundle is stacked on the liner.

2. The manufacturing method according to claim 1,
wherein the preparation process comprises a process of providing the fiber bundle in which no resin adheres to the fibers on the one side of the fiber bundle.

3. The manufacturing method according to claim 1,
wherein the preparation process comprises a process of providing the fiber bundle by bundling resin-impregnated fibers and non-resin-impregnated fibers.

4. The manufacturing method according to claim 1,
wherein the preparation process comprises a process of providing the fiber bundle by bringing a resin sheet into contact with the fibers on the other side of the fiber bundle.

5. A tank manufacturing apparatus, comprising:
a fiber bundle supplier that is configured to supply a fiber bundle in which a resin adheres to at least part of fibers when the fiber bundle is viewed in a section perpendicular to a longitudinal direction of fibers and in which an amount of the resin adhering to fibers on one side of the fiber bundle is smaller than an amount of the resin adhering to fibers on the other side of the fiber bundle in the section; and
a fiber feeder configured to wind the fiber bundle on a rolling body that includes a liner and a fiber bundle already wound on the liner, such that the fibers on the other side of the fiber bundle is located below the fibers on the one side in a stacking direction of the fiber bundle when the fiber bundle is stacked on the liner.

6. The tank manufacturing apparatus according to claim 5,
wherein the fiber bundle supplier comprises:
a first fiber wind-off assembly and a second fiber wind-off assembly that are respectively configured to wind off fibers; and
a resin impregnation assembly configured to impregnate the fibers wound off from the second fiber wind-off assembly with the resin, wherein
the fiber bundle supplier supplies the fiber bundle by bundling the fibers impregnated with the resin by the resin impregnation assembly and the fibers wound off from the first fiber wind-off assembly.

7. The tank manufacturing apparatus according to claim 5,
wherein the fiber bundle supplier comprises:
a fiber wind-off assembly that is configured to wind off fibers; and
a resin supplier that is configured to cause the resin to adhere to the fibers wound off from the fiber wind-off assembly.

8. The tank manufacturing apparatus according to claim 5,
wherein the fiber bundle supplier comprises:
a fiber wind-off assembly that is configured to wind off fibers; and
a resin sheet supplier that is configured to supply a resin sheet, wherein
the fiber bundle supplier supplies the fiber bundle by causing the resin sheet supplied from the resin sheet supplier to come in contact with the fibers wound off from the fiber wind-off assembly.
